(19) United States
(12) Patent Application Publication
(10) Pub. No.: US 2012/0134055 A1
(43) Pub. Date: May 31, 2012

(54) HEAD AND DISK DRIVE PROVIDED WITH THE SAME

(75) Inventors: Naozumi Tsuda, Ome-shi (JP); Akiyo Mizutani, Kawasaki-shi (JP); Toru Watanabe, Kawasaki-shi (JP); Takahiro Imamura, Ome-shi (JP)

(73) Assignee: KABUSHIKI KAISHA TOSHIBA, Tokyo (JP)

(21) Appl. No.: 13/225,292

(22) Filed: Sep. 2, 2011

(30) Foreign Application Priority Data
Nov. 30, 2010 (JP) 2010-266711

(51) Int. Cl. G11B 5/60

(52) U.S. Cl. 360/235.6; 360/235.4; 360/235.5; G9B/5.229

(57) ABSTRACT

According to one embodiment, a head includes a head slider including a bearing surface and configured to fly by an airflow between the recording medium surface and the bearing surface, and a recording element and a reproduction element arranged in an outflow end portion of the head slider with respect to the airflow. The bearing surface includes a first pressure generating portion on an inflow end portion of the head slider with respect to the airflow, configured to generate a pressure, a second pressure generating portion on the outflow end portion, configured to generate a pressure, and a third pressure generating portion between the first and second pressure generating portions at a transverse central part of the bearing surface, configured to generate a pressure higher than that generated by the first pressure generating portion and lower than that generated by the second pressure generating portion.

### CROSS-REFERENCE TO RELATED APPLICATIONS

This application is based upon and claims the benefit of priority from Japanese Patent Application No. 2010-266711, filed Nov. 30, 2010; the entire contents of which are incorporated herein by reference.

### FIELD

Embodiments described herein relate generally to a head used in a disk drive, such as a magnetic disk drive, and the disk drive provided with the same.

### BACKGROUND

A disk drive, such as a magnetic disk drive, comprises a magnetic disk, spindle motor, magnetic head, and carriage assembly. The magnetic disk for use as a recording medium is arranged in a case. The spindle motor supports and rotates the disk. The magnetic head reads data from and writes data to the disk. The carriage assembly supports the head for movement relative to the disk. The head comprises a head slider mounted on a suspension of the carriage assembly and a head section on the slider. The head section comprises a reproduction element and recording element.

The head slider has an air bearing surface (ABS) opposed to a recording surface of the magnetic disk. A predetermined head load directed to a magnetic recording layer of the disk is applied to the slider by the suspension. When the magnetic disk drive is operating, an airflow is produced between the disk in rotation and the head slider. Based on the principle of aerodynamic lubrication, a force (positive pressure) causing the slider to fly above the recording surface of the disk acts on the ABS of the slider. By balancing this flying force with the head load, the head slider is caused to fly with a gap above the recording surface of the disk. There is known a disk drive in which a negative-pressure cavity or dynamic pressure generating groove is formed near the center of a facing surface of a head slider in order to prevent variation in the flying height of the slider.

A magnetic disk drive is assembled a clean room. In general, air in the clean room contains a plurality of gasified compounds ranging from low-boiling-point organic compounds, such as toluene, xylene, etc., to high-boiling-point organic compounds, such as dioctyl phthalate (DOP), which is used as a plasticizer for polyvinyl chloride, nitrocellulose, methacrylic resin, chlorinated rubber, etc.

If the magnetic disk drive is assembled with the gasified organic compounds left in the case, the organic compounds may liquefy and adhere to the recording and reproduction elements of the head slider when the elements are subjected to a high pressure during the operation of the disk drive. If the organic compounds adhere to the recording and reproduction elements, they stick fast to the elements when the disk drive is not operating, thereby causing an unrecoverable failure, such as a continuous high-fly write (HFW).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary plan view showing an HDD according to a first embodiment;

FIG. 2 is an exemplary enlarged side view showing a magnetic head portion of the HDD;

FIG. 3 is an exemplary perspective view showing the ABS side of a head slider of the magnetic head;

FIG. 4 is an exemplary plan view showing the ABS side of the head slider;

FIG. 5 is an exemplary sectional view of the head slider taken along line III-III of FIG. 4;

FIG. 6 is an exemplary enlarged perspective view showing a third pressure generating portion of the head slider;

FIG. 7 is an exemplary side view showing the magnetic head in a flying state;

FIG. 8 is an exemplary diagram showing a pressure generation distribution in the longitudinal direction of the head slider;

FIG. 9 is an exemplary perspective view showing a third pressure generating portion of a magnetic head according to a second embodiment; and

FIG. 10 is an exemplary perspective view showing a third pressure generating portion of a magnetic head according to a third embodiment.

### DETAILED DESCRIPTION

Various embodiments will be described hereinafter with reference to the accompanying drawings.

In general, according to one embodiment, a head comprises: a head slider comprising a bearing surface and configured to fly by an airflow between the recording medium surface and the bearing surface; and a recording element and a reproduction element arranged in an outflow end portion of the head slider with respect to the airflow. The bearing surface of the head slider comprises a first pressure generating portion on an inflow end portion of the head slider with respect to the airflow, configured to generate a pressure, a second pressure generating portion on the outflow end portion, configured to generate a pressure, and a third pressure generating portion between the first and second pressure generating portions at a transverse central part of the bearing surface, configured to generate a pressure higher than that generated by the first pressure generating portion and lower than that generated by the second pressure generating portion.

An embodiment in which a disk drive is applied to a hard disk drive (HDD) will now be described in detail.

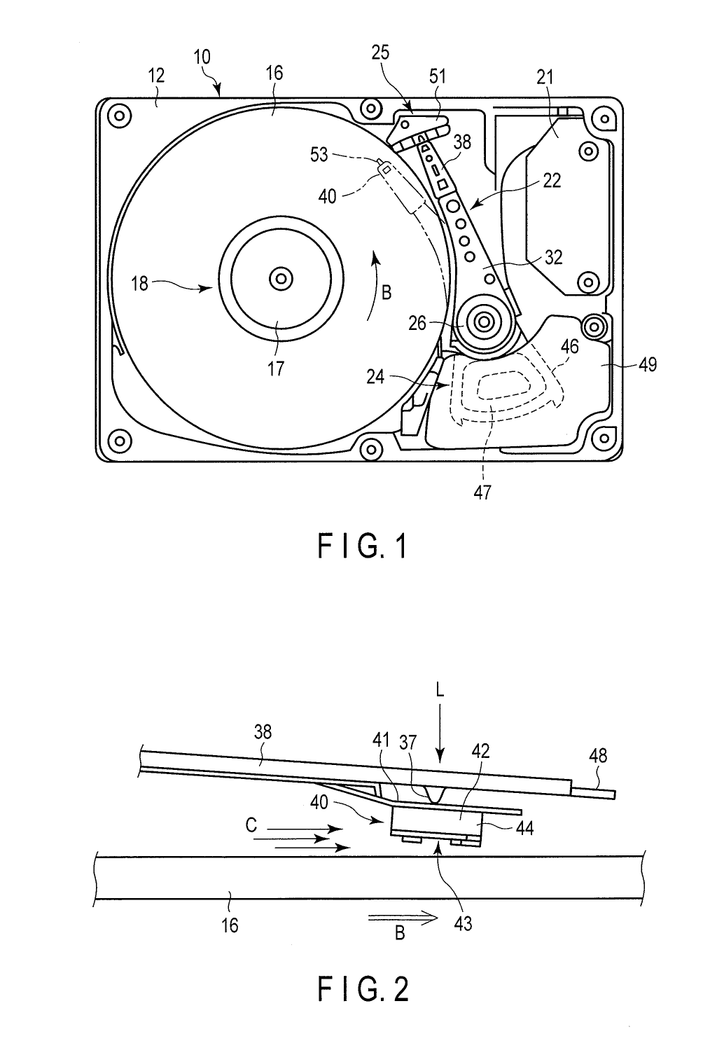

FIG. 1 shows the internal structure of the HDD with its top cover removed. As shown in FIG. 1, the HDD comprises a housing 10. The housing 10 comprises a base 12 in the form of an open-topped rectangular box and a top cover (not shown), which is attached to the base by screws so as to close the top opening of the base.

The housing 10 contains a magnetic disk 16 for use as a recording medium and a spindle motor 18 as a drive section that supports and rotates the disk 16. The spindle motor 18 is arranged on the bottom wall of the base 12. The magnetic disk 16 has a diameter of, for example, 65 mm (2.5 inches) and comprises magnetic recording layers on its upper and lower surfaces, individually. A lubricant, such as oil, is applied to a thickness of about 1 nm to the surfaces of the disk 16. The disk is mounted on a hub (not shown) of the spindle motor 18 and secured to the hub by a clamping spring 17. Thus, the disk 16 is supported parallel to the bottom wall of the base 12. The disk 16 is rotated at a predetermined speed, e.g., 5,400 or 7,200 rpm, by the spindle motor 18.

The housing 10 contains a plurality of magnetic heads 40, carriage assembly 22, and voice coil motor (VCM) 24. The magnetic heads 40 write data to and read data from the magnetic disk 16. The carriage assembly 22 supports the heads for movement relative to the disk. The VCM 24 pivots and positions the carriage assembly. The housing 10 further contains a ramp loading mechanism 25, board unit 21, etc. The ramp loading mechanism 25 holds the heads in a retracted position off the disk when the heads are moved to the outer periphery of the disk. The board unit 21 comprises a head IC and the like.

A printed circuit board (not shown) is attached to the outer surface of the bottom wall of the base 12 by screws. This circuit board controls the operations of the spindle motor 18, VCM 24, and magnetic heads 40 through the board unit 21.

The carriage assembly 22 comprises a bearing unit 26 and a plurality of arms 32 extending from the bearing unit. The arms 32 are located parallel to the surfaces of the magnetic disk 16 so as to be spaced apart from one another and extend in the same direction from the bearing unit 26. The carriage assembly 22 comprises elastically deformable suspensions 38 each in the form of an elongated plate. Each suspension 38 is a plate spring having its proximal end secured to the distal end of its corresponding arm 32 by spot welding or adhesive bonding and extends from the arm. The suspensions 38 may be formed integrally with their corresponding arms 32.

As shown in FIG. 2, each magnetic head 40 comprises a substantially cuboid head slider 42 and head section 44 for recording and reproduction thereon and is secured to a gimbal 41 on the distal end portion of the suspension 38. A dimple or substantially hemispherical protrusion 37, projecting on the magnetic head side in this case, is formed at that position on the suspension 38 which faces a head mounting portion of the gimbal 41, that is, the central part of the magnetic head 40. The protrusion 37 abuts a substantially central part of a flat surface of the head slider 42 with the gimbal 41 between them. The gimbal 41 is elastically pressed against the protrusion 37 by its own elasticity. Thus, the magnetic head 40 and the head mounting portion of the gimbal 41 can be displaced in the pitch and roll directions or vertically around the protrusion 37. Further, the magnetic head 40 is subjected to a predetermined head load L produced by the spring force of the suspension 38 and directed to the surface of the magnetic disk 16.

As shown in FIG. 1, the carriage assembly 22 comprises a support frame 46 extending from the bearing unit 26 on the opposite side to the arms 32. The support frame supports a voice coil 47 that constitutes a part of the VCM 24. The support frame 46 is integrally molded on the outer periphery of the voice coil 47 of synthetic resin. The voice coil 47 is located between a pair of yokes 49 secured to the base 12. Thus, the voice coil, along with the yokes and a magnet (not shown) secured to one of the yokes, constitutes the VCM 24. If the voice coil 47 is energized, the carriage assembly 22 pivots around the bearing unit 26, whereupon each magnetic head 40 is moved to and positioned on a desired track of the corresponding disk 16.

The ramp loading mechanism 25 comprises a ramp 51 and tabs 48. The ramp 51 is arranged on the bottom wall of the base 12 and located outside the magnetic disk 16. The tabs 48 extend individually from the respective distal ends of the suspensions 38. As the carriage assembly 22 pivots to its retracted position outside the disk 16, each of the tabs 48 engages with a ramp surface formed on the ramp 51 and is then pushed up the ramp surface. Thereupon, the heads 40 are unloaded.

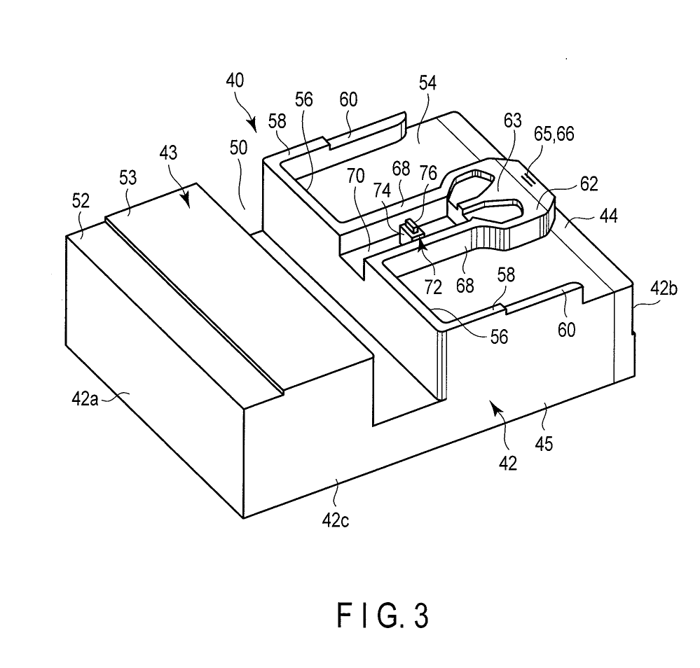

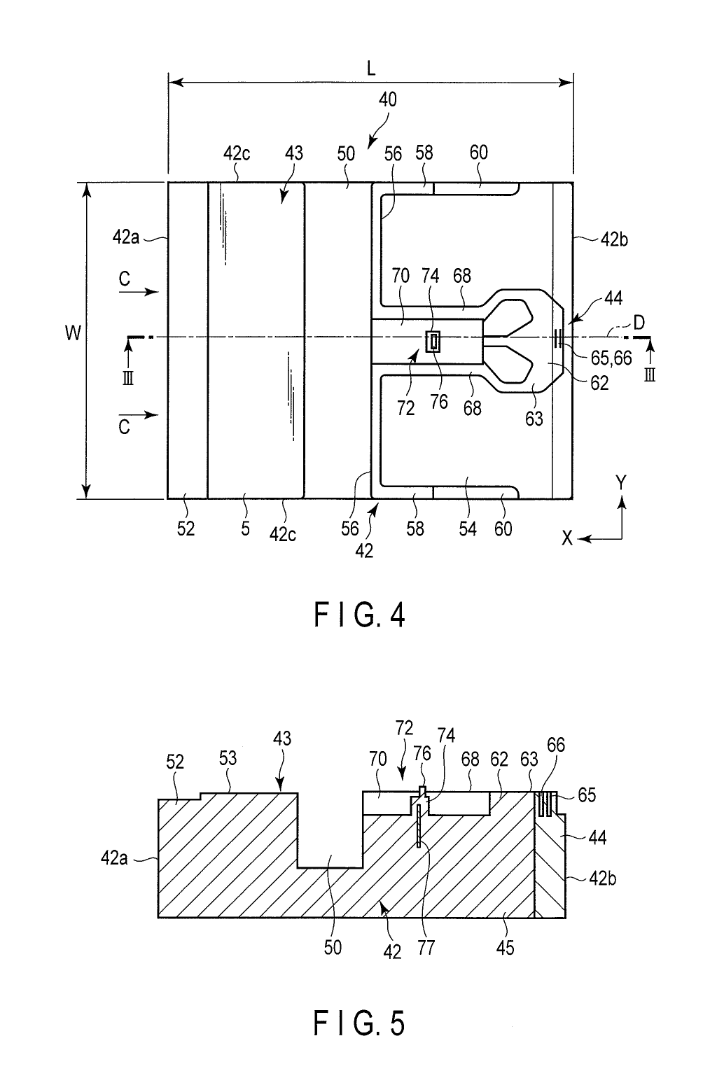

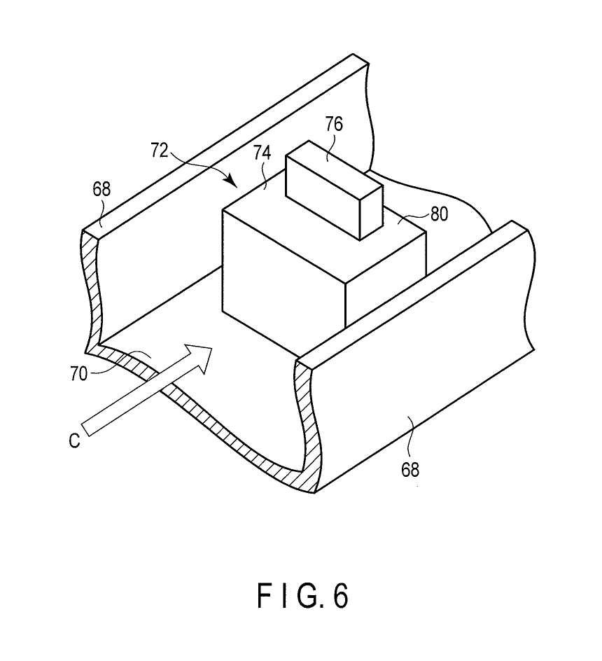

The following is a detailed description of a configuration of the magnetic head 40. FIG. 3 is a perspective view showing the head slider of the magnetic head, FIG. 4 is a plan view of the head slider, FIG. 5 is a sectional view of the magnetic head taken along line III-III of FIG. 4, and FIG. 6 is an enlarged perspective view showing a central step portion of the head slider.

As shown in FIGS. 3 to 5, the magnetic head 40 is constructed as a flying head and comprises the head slider 42. The head slider 42 comprises a slider body 45 formed of, for example, a sintered body (AlTic or Al₂O₃-Tic) containing alumina and titanium carbide, and the head section 44 formed of a thin film on the outflow end of the slider body. The head slider 42, which is substantially cuboid as a whole, comprises a rectangular air-bearing surface (ABS) 43, inflow end face 42a, outflow end face 42b, and a pair of side faces 42c. The ABS 43 is configured to face a surface of the magnetic disk 16. The inflow and outflow end faces 42a and 42b individually extend at right angles to the ABS. The side faces 42c extend between the end faces 42a and 42b.

The longitudinal direction of the ABS 43 is defined as a first direction X, and the transverse direction perpendicular thereto as a second direction Y. The head slider 42 is formed as a femtoslider having a length L of 1.25 mm or less, e.g., 0.85 mm, in the first direction X and a width W of 1.0 mm or less, e.g., 0.7 mm, in the second direction Y.

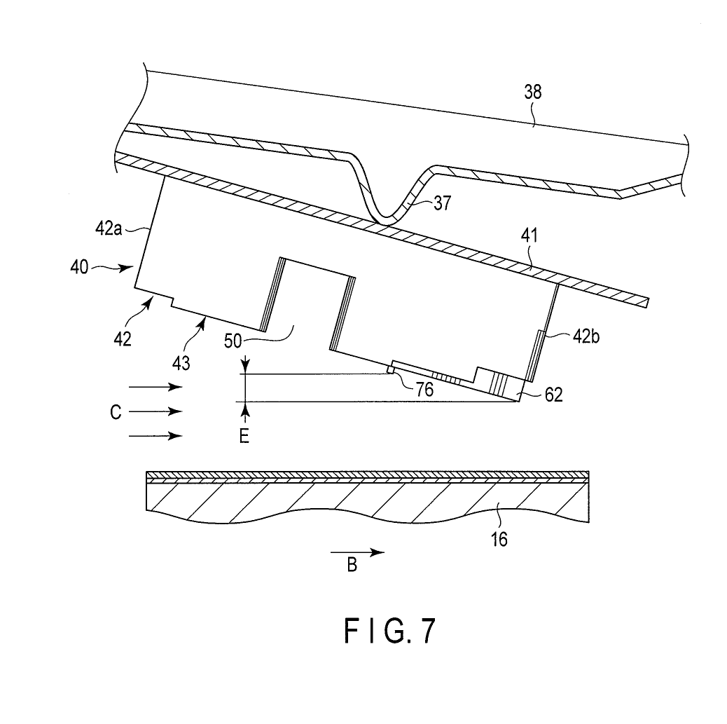

The head slider 42 is caused to fly by an airflow C (FIGS. 2 and 7) that is produced between the disk surface and the ABS 43 as the magnetic disk 16 rotates. When the HDD is operating, the ABS 43 of the slider 42 never fails to be opposed to the disk surface across a gap. The direction of the airflow C is coincident with a direction of rotation B of the disk 16. The head slider 42 is located on the surface of the disk 16 in such a manner that the first direction X of the ABS 43 is substantially coincident with the direction of the airflow C.

As shown in FIGS. 3 to 5, a band-shaped negative-pressure trough 50 is formed substantially in the central part of the ABS 43 so as to extend throughout the length in the second direction Y. If the thickness of the head slider 42 is adjusted to, for example, 0.23 mm, the depth of the trough 50 is 800 to 1,500 nm, e.g., 1,500 nm. By means of the trough 50, a negative pressure can be generated on the central part of the ABS 43 at every feasible yaw angle for the HDD.

A substantially rectangular leading step 52 is formed at an inflow end portion of the ABS 43. The leading step 52 projects from the bottom surface of the negative-pressure trough 50 and is located on the inflow side of the trough 50 with respect to the airflow C.

In order to maintain the pitch angle of each magnetic head 40, a leading pad 53 that supports the head slider 42 by means of an air film is formed protruding from the leading step 52. The leading pad 53 continuously extends throughout the width of the leading step 52 in the second direction Y and is deviated downstream from the inflow end face 42a of the slider 42. The leading pad 53 and leading step 52 constitute a first pressure generating portion.

A negative-pressure cavity 54, a recess, is formed in the ABS 43, ranging from its substantially central part to the outflow end side. The cavity 54 is located on the outflow end side of the negative-pressure trough 50 and opens toward an outflow end face 44b of the head slider 42. The cavity 54 is formed to be shallower than the negative-pressure trough 50, that is, higher than the bottom surface of the trough 50.

A pair of rib-like intermediate steps 56, a pair of side steps 58, and a pair of skirts 60 are formed on the ABS 43 so as to enclose the negative-pressure cavity 54. The intermediate steps 56 are located between the negative-pressure trough 50 and negative-pressure cavity 54 and extend in the second direction Y between the opposite side edges of the ABS 43. The intermediate steps 56 project from the bottom surface of the negative-pressure cavity 54 and are located on the inflow side of the cavity 54 with respect to the airflow C.

The side steps 58 are formed individually along the side edges of the ABS 43 and extend from their corresponding intermediate steps 56 toward the outflow end of the ABS 43. The side steps 58 project from the bottom surface of the negative-pressure cavity 54.

The skirts 60 are formed individually along the side edges of the ABS 43 and individually extend straight in the first direction X from the intermediate steps 56 to the vicinity of the outflow end of the ABS 43. The skirts 60 project from the bottom surface of the negative-pressure cavity 54 and are formed to be lower than the side steps 58.

The intermediate steps 56, side steps 58, and skirts 60 are arranged substantially symmetrically with respect to the central axis D of the head slider 42 and form a substantially U-shaped structure as a whole, closed upstream and open downstream. The steps 56 and 58 and skirts 60 define the negative-pressure cavity 54.

The head slider 42 comprises a trailing step 62 formed on the outflow end portion of the ABS 43 with respect to the direction of the airflow C. The trailing step 62 projects from the bottom surface of the negative-pressure cavity 54 so that its top surface is flush with that of the leading step 52. The trailing step 62 is located substantially corresponding to the center of the ABS 43 with respect to the second direction Y. A trailing pad 63 that supports the head slider 42 by means of an air film protrudes from the top surface of the trailing step 62. The trailing pad 63 is formed flush with the leading pad 53, intermediate steps 56, and side steps 58. The trailing step 62 and trailing pad 63 constitute a second pressure generating portion.

The head section 44 of the magnetic head 40 comprises a recording element 65 and reproduction element 66 for recording and reproduction on the magnetic disk 16. These elements 65 and 66 are embedded in the downstream end portion of the head slider 42 with respect to the direction of the airflow C, that is, in the trailing step 62 in this case. The respective distal end portions of the recording and reproduction elements 65 and 66 are exposed in the ABS 43 at a position corresponding to the trailing pad 63.

The ABS 43 of the head slider 42 comprises a pair of center rails 68, which individually extend in the first direction X from the intermediate steps 56 to the trailing step 62. The center rails 68 are located individually on the opposite sides of the central axis D of the head slider 42 and face each other across a gap in the second direction Y. The height of the center rails 68 from the bottom surface of the negative-pressure cavity 54 is equal to the height of the intermediate steps 56 and trailing pad 63. A guide groove 70 that guides the airflow to the trailing step 62 and trailing pad 63 is defined between the pair of center rails 68. The groove 70 opens into the negative-pressure trough 50.

As shown in FIGS. 3 to 6, the ABS 43 of the head slider 42 comprises a third pressure generating portion 72, which is arranged between the trailing pad 63 and leading pad 53, that is, upstream of the trailing pad 63 with respect to the airflow C, at the central part with respect to the second direction Y. The third pressure generating portion 72 comprises a substantially rectangular center step 74, which is set up on the bottom surface of the guide groove 70, and a substantially rectangular center pad 76 protruding from the center step 74. The center step 74 is in the form of an independent island separated from the center rails 68 and trailing step 62.

Within the guide groove 70, the third pressure generating portion 72 is arranged on the central axis D of the head slider 42 and located as close to the protrusion 37 (FIGS. 2 and 7) of the suspension, which serves as a pivotal center of the slider 42 with respect to the pitch and roll directions, as possible.

The center pad 76 is formed higher from the bottom surface of the negative-pressure cavity 54 than the center rails 68 and trailing pad 63. The center pad 76 has a cross-sectional area smaller than the area of the top surface of the center step 74. Liquefied organic contaminations (described later) are trapped and held on a shoulder portion 80, which is defined by the upper surface of the center step 74 and the center pad 76, on the downstream side of the center pad 76 with respect to the airflow C.

In the head slider 42, as shown in FIG. 5, a heater 77 is embedded near the center step 74. The projection height of the third pressure generating portion 72 can be adjusted by energizing the heater 77 to heat and thermally expand the third pressure generating portion 72. By adjusting this projection height, the pressure to be generated at the third pressure generating portion 72 can be adjusted.

According to the HDD constructed in this manner, each magnetic head 40 is caused to fly by the airflow C that is produced between the surface of the magnetic disk 16 and the ABS 43 as the disk rotates. Thus, when the HDD is operating, the ABS 43 of the head slider 42 never fails to be opposed to the disk surface across a gap. When the magnetic head 40 flies, as shown in FIG. 7, the recording and reproduction elements of the head section 44 are inclined to be closest to the disk surface. In this flying state, the center pad 76 of the head slider 42 is spaced farther apart (by distance E) from the disk surface than the recording and reproduction elements.

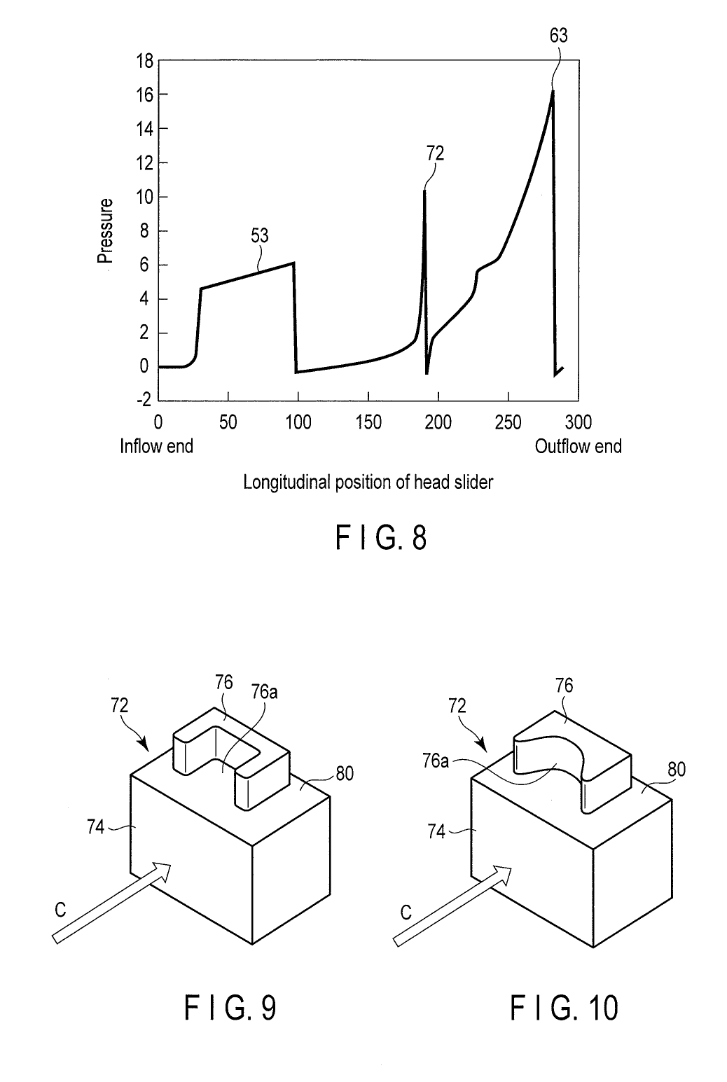

By means of the negative-pressure trough 50 and negative-pressure cavity 54 in the ABS 43 of the head slider 42, the magnetic head 40 can generate a negative pressure on the central part of the ABS 43 at every feasible yaw angle for the HDD. As the airflow C passes along the ABS 43 of the head slider 42, moreover, positive pressures are generated individually at the positions of the leading pad 53, center pad 76, and trailing pad 63. FIG. 8 shows a pressure generation distribution in the first direction X or the longitudinal direction of the ABS 43. A higher pressure is generated at the center pad 76 of the third pressure generating portion 72 than at the leading pad 53. A still higher pressure is generated at the trailing pad 63 from which the recording and reproduction elements are exposed.

Thus, the third pressure generating portion 72 that generates a higher pressure than at the leading pad 53 on the inflow end side is arranged upstream of the trailing pad 63, from which the recording and reproduction elements are exposed, with respect to the airflow C. In this way, introduced air is previously subjected to a high pressure of 1 atm. or more, and gaseous organic compounds contained in the air are liquefied and adherently held on the shoulder portion 80 of the third pressure generating portion 72. Since the third pressure generating portion 72 is an independent structure, the liquefied organic compounds can never reach the recording and reproduction elements. Since the air having passed through the third pressure generating portion 72 once causes the organic compounds to separate at the third pressure generating portion, air that contains the organic compounds at reduced concentrations reaches the trailing pad 63. Thereupon, the amount of the organic compounds separated at the trailing pad 63 and the recording and reproduction elements on which a high pressure is generated is greatly reduced. Thus, those organic compounds which cannot be easily trapped in a gaseous state can be prevented from adhering to the trailing pad with the recording and reproduction elements.

The amount of the organic compounds previously separated and removed at the third pressure generating portion 72 depends on the concentrations of the organic compounds in the HDD and a pressure generated at the third pressure generating portion 72. The higher the pressure, the more the organic compounds can be removed in advance. If the organic compounds are in a saturated state at the HDD operating temperature in a 1-atm environment, for example, half of them are separated at the third pressure generating portion 72 when the atmospheric pressure only becomes 2 atm. In the case shown in FIG. 8, the pressure generated at the third pressure generating portion 72 is 10 atm, so that the amount of the organic compounds that reaches the recording and reproduction elements, that is, the trailing pad 63, is reduced to 1/10. By adjusting the projection height of the third pressure generating portion 72 by means of the heater 77, moreover, the generated pressure can be increased or reduced to regulate the capture of the organic compounds.

Since the third pressure generating portion 72 is designed to expose the airflow to a high pressure on the upstream side of the recording and reproduction elements, it can be made small enough not to affect the flying attitude of the head slider 42. Further, the third pressure generating portion 72 is arranged on the central axis D of the head slider 42 and near the pivotal center of the slider, so that the influence of the pressure at that portion on the flying attitude of the slider can be reduced.

Thus, there may be provided a head with improved reliability and stability, in which contaminations such as organic compounds can be prevented from adhering to recording reproduction elements, and an HDD provided with the head.

The center pad 76 that constitutes the third pressure generating portion 72 is not limited to the rectangular shape and may be of another shape. As in a second embodiment shown in FIG. 9, for example, a center pad 76 may be substantially U-shaped, comprising a rectangular recess 76a on the upstream side. Alternatively, as in a third embodiment shown in FIG. 10, a center pad 76 may be configured to comprise an arcuate recess 76a located upstream with respect to the airflow C. Thus, the center pad 76 comprising the upstream recess 76a can facilitate generation of a positive pressure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the present invention is not limited to femto-sliders and may also be applied to pico-sliders, pemto-sliders, or other larger sliders. The number of magnetic disks used in the disk drive may be increased without being limited to one.

What is claimed is:

1. A head comprising:
a head slider comprising a bearing surface, the head slider configured to fly in an airflow between a recording medium surface and the bearing surface; and
a recording element and a reproduction element, the recording element and the reproduction element closer to an outflow end portion of the head slider than to an inflow end portion of the head slider with respect to the airflow,
the bearing surface of the head slider comprising:
a first pressure generating portion on an inflow end portion of the head slider with respect to the airflow, configured to generate a pressure;
a second pressure generating portion on the outflow end portion, configured to generate a pressure; and
a third pressure generating portion between the first and second pressure generating portions, the third pressure generating portion at a transverse central part of the bearing surface, the third pressure generating portion configured to generate a pressure higher than that generated by the first pressure generating portion and lower than that generated by the second pressure generating portion.

2. The head of claim 1, wherein the third pressure generating portion is separate from the second pressure generating portion on the bearing surface.

3. The head of claim 2, wherein:
the bearing surface of the head slider comprises a negative-pressure cavity defined by a recess;
the first pressure generating portion comprises a leading pad on an airflow inlet side of the negative-pressure cavity, the first pressure generating portion coupled to a bottom surface of the negative-pressure cavity;
the second pressure generating portion comprises a trailing pad on an airflow outlet side of the negative-pressure cavity, the second pressure generating portion coupled to the bottom surface of the negative-pressure cavity; and
the third pressure generating portion coupled to the bottom surface of the negative-pressure cavity, the projection height of the third pressure generating portion higher than the height of the trailing pad.

4. The head of claim 3, wherein the third pressure generating portion comprises a center step coupled to the bottom surface of the negative-pressure cavity, a center pad coupled to the center step, and a shoulder portion defined by the center step and the center pad, the shoulder portion located on the downstream side of the center pad with respect to the airflow.

5. The head of claim 4, wherein:
the bearing surface of the head slider comprises a pair of center rails oriented in the direction of the airflow towards the trailing pad;
the bearing surface of the head slider comprises a guide groove between the center rails, the guide groove configured to guide the airflow to the trailing pad; and
the third pressure generating portion is in the guide groove and separated from the center rails.

6. The head of claim 1, further comprising a heater in the head slider, the heater configured to heat the third pressure generating portion to adjust the projection height of the third pressure generating portion.

7. The head of claim 1, wherein the third pressure generating portion is on a central axis of the head slider and on a pivotal center of the head slider.

8. A head comprising:
a head slider comprising a bearing surface, the head slider configured to fly in an airflow between a recording medium surface and the bearing surface; and
a head section closer to an outflow end portion of the head slider than to an inflow end portion of the head slider with respect to the airflow, the head section configured to record data in and reproduce data from the recording medium,
the bearing surface of the head slider comprising:
a negative-pressure cavity defined by a recess, the negative-pressure cavity configured to generate a negative pressure;
a leading pad on an airflow inlet side of the negative-pressure cavity;
a trailing pad on an airflow outlet side of the negative-pressure cavity, the trailing pad comprising the head section;
a pair of center rails oriented in the direction of the airflow towards the trailing pad;
a guide groove between the center rails, the guide groove configured to guide the airflow to the trailing pad, and
a pressure generating portion in the guide groove, the pressure generating portion configured to generate a pressure higher than a pressure generated by the leading pad and lower than a pressure generated by the trailing pad.

9. A disk drive comprising:
a disk recording medium;
a drive section configured to rotate the recording medium; and
the head of claim 1, the head configured to perform data processing on the recording medium.

10. The disk drive of claim 9, wherein the third pressure generating portion of the bearing surface of the head slider is separate from the second pressure generating portion on the bearing surface of the head slider.

11. The disk drive of claim 10, wherein:
the bearing surface of the head slider comprises a negative-pressure cavity defined by a recess;
the first pressure generating portion comprises a leading pad on an airflow inlet side of the negative-pressure cavity, the leading pad coupled to a bottom surface of the negative-pressure cavity;
the second pressure generating portion comprises a trailing pad arranged on an airflow outlet side of the negative-pressure cavity and coupled to the bottom surface of the negative-pressure cavity; and
the third pressure generating portion is coupled to the bottom surface of the negative-pressure cavity, the projection height of the third pressure generating portion being higher than the height of the trailing pad.

12. The disk drive of claim 11, wherein the third pressure generating portion comprises a center step coupled to the bottom surface of the negative-pressure cavity, a center pad coupled to the center step, and a shoulder portion defined by the center step and the center pad, the shoulder portion located on the downstream side of the center pad with respect to the airflow.

13. The disk drive of claim 12, wherein the bearing surface of the head slider comprises a pair of center rails oriented in the direction of the airflow toward the trailing pad, and wherein a guide groove is between the center rails, the guide groove configured to guide the airflow to the trailing pad, and the third pressure generating portion in the guide groove and separated from the center rails.

14. The disk drive of claim 9, further comprising a heater arranged in the head slider, the heater configured to heat the third pressure generating portion to adjust the projection height of the third pressure generating portion.

15. The disk drive of claim 9, wherein the third pressure generating portion is on a central axis of the head slider and on a pivotal center of the head slider.
